(19) United States
(12) Patent Application Publication
(10) Pub. No.: US 2021/0335007 A1
(43) Pub. Date: Oct. 28, 2021

(54) ACTIVE TARGETS FOR AUTOMATIC OPTICAL SENSOR ALIGNMENT

(71) Applicant: GM Global Technology Operations LLC, Detroit, MI (US)

(72) Inventors: Wende Zhang, Birmingham, MI (US); Fred W. Huntzicker, Ann Arbor, MI (US); Hao Yu, Troy, MI (US)

(21) Appl. No.: 16/859,436

(22) Filed: Apr. 27, 2020

(51) Int. Cl. G06T 7/80; G06T 7/73

(52) U.S. Cl. CPC G06T 7/80; G06T 2207/30204; G06T 2207/30252; G06T 7/73

(57) ABSTRACT

A system and method to perform automatic alignment of an optical sensor of a vehicle involve disposing two or more active targets at known locations in an alignment station. Each of the two or more active targets have at least two visibly different states. The method includes coding a change among the at least two visibly different states for the two or more active targets. Images obtained by the optical sensor of the two or more active targets are processed to identify features and perform the alignment of the optical sensor with another sensor of the vehicle or with the vehicle.

### INTRODUCTION

The subject disclosure relates to active targets for automatic optical sensor alignment.

Vehicles (e.g., automobiles, trucks, construction equipment, farm equipment, automated factory equipment) increasingly include sensors to obtain information about the sensor and its environment. Exemplary sensors include radio detection and ranging (radar) systems, light detection and ranging (lidar) systems, and cameras. The sensors can be located anywhere within or on the vehicle. Thus, information obtained at a sensor may not necessarily indicate the information relative to the orientation and position of the vehicle. Accordingly, it is desirable to provide active targets for automatic optical sensor alignment.

### SUMMARY

In one exemplary embodiment, a method of performing automatic alignment of an optical sensor of a vehicle includes disposing two or more active targets at known locations in an alignment station. Each of the two or more active targets have at least two visibly different states. The method also includes coding a change among the at least two visibly different states for the two or more active targets. Images obtained by the optical sensor of the two or more active targets are processed to identify features and perform the alignment of the optical sensor with another sensor of the vehicle or with the vehicle.

In addition to one or more of the features described herein, the disposing the two or more active targets in the alignment station is based on a position of the optical sensor of the vehicle along a path past the two or more active targets in the alignment station.

In addition to one or more of the features described herein, the disposing the two or more active targets in the alignment station is based on a location of one or more occlusions blocking a view of the two or more active targets from the optical sensor.

In addition to one or more of the features described herein, the coding includes spatial coding of the two or more active targets based on relative position of the active targets.

In addition to one or more of the features described herein, the coding includes defining a pattern of the change among the at least two visibly different states among the two or more active targets such that the pattern facilitates identification of the two or more active targets.

In addition to one or more of the features described herein, the coding includes defining a duty cycle of each of the two or more active targets over a number of frame durations of the optical sensor, wherein the defining the duty cycle includes decreasing the duty cycle over the number of frame durations.

In addition to one or more of the features described herein, the coding includes defining a different frequency for the change among the at least two visibly different states for different ones of the two or more active targets.

In addition to one or more of the features described herein, the coding includes defining a different pattern of the change among the at least two visibly different states for different ones of the two or more active targets.

In addition to one or more of the features described herein, the defining the different pattern of the change among the at least two visibly different states includes conveying an identify of the different ones of the two or more active targets based on the pattern of the change among the at least two visibly different states or conveying a location of the different ones of the two or more active targets based on the pattern of the change among the at least two visibly different states.

In addition to one or more of the features described herein, the method also includes disposing one or more passive targets at known locations in the alignment station, each of the one or more passive targets having a single visible state.

In another exemplary embodiment, a system to perform automatic alignment of an optical sensor of a vehicle includes two or more active targets positioned at known locations in an alignment station. Each of the two or more active targets have at least two visibly different states. The system also includes a controller to code a change among the at least two visibly different states for the two or more active targets. Images obtained by the optical sensor of the two or more active targets are processed to identify features and perform the alignment of the optical sensor with another sensor of the vehicle or with the vehicle.

In addition to one or more of the features described herein, a position of the two or more active targets in the alignment station is based on a position of the optical sensor of the vehicle along a path past the two or more active targets in the alignment station.

In addition to one or more of the features described herein, a position of the two or more active targets in the alignment station is based on a location of one or more occlusions blocking a view of the two or more active targets from the optical sensor.

In addition to one or more of the features described herein, the two or more active targets are positioned by spatial coding based on relative position of the active targets.

In addition to one or more of the features described herein, the controller codes by defining a pattern of the change among the at least two visibly different states among the two or more active targets such that the pattern facilitates identification of the two or more active targets.

In addition to one or more of the features described herein, the controller codes by defining a duty cycle of each of the two or more active targets over a number of frame durations of the optical sensor, wherein the defining the duty cycle includes decreasing the duty cycle over the number of frame durations.

In addition to one or more of the features described herein, the controller codes by defining a different frequency for the change among the at least two visibly different states for different ones of the two or more active targets.

In addition to one or more of the features described herein, the controller codes by defining a different pattern of the change among the at least two visibly different states for different ones of the two or more active targets.

In addition to one or more of the features described herein, the controller defines the different pattern of the change among the at least two visibly different states to convey an identify of the different ones of the two or more active targets based on the pattern of the change among the at least two visibly different states or to convey a location of the different ones of the two or more active targets based on the pattern of the change among the at least two visibly different states.

In addition to one or more of the features described herein, the system also includes one or more passive targets disposed at known locations in the alignment station, each of the one or more passive targets having a single visible state.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that undergoes automatic optical sensor alignment using active targets according to one or more embodiments;

FIG. 2 depicts an exemplary station with active targets for automatic optical sensor alignment according to one or more embodiments;

FIG. 3 illustrates spatial coding of active targets used for automatic optical sensor alignment according to one or more embodiments; and

FIG. 4 is a process flow of a method of using active targets for automatic optical sensor alignment according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, different sensors may be included in a vehicle to obtain information about the vehicle and its surroundings. This information may facilitate semi-autonomous or autonomous operation of the vehicle, for example. Among the exemplary sensors that may be available in a vehicle, a camera and a lidar system are optical sensors. As also previously noted, information obtained at a sensor, in a sensor coordinate system, must be transformed to provide the information relative to the vehicle, in the vehicle coordinate system, in order to use the information to control vehicle operation and to ensure that all information from all sensors is in the same coordinate system.

Embodiments of the systems and methods detailed herein pertain to using active targets for automatic optical sensor alignment. Sensor alignment refers to determining sensor position and orientation relative to the vehicle coordinate system. In some cases (e.g., for sensor fusion), sensor alignment may also refer to determining the position and orientation of a sensor relative to the coordinate system of another sensor. Sensor alignment may be performed as part of the manufacturing process, for example (e.g., during calibration or design validation and testing). According to one or more embodiments, optical sensor alignment is performed automatically using active targets in addition to the conventionally used passive targets. In particular, active targets are coded, as described herein, and used along with passive targets to facilitate automatic alignment of optical sensors like cameras and lidar systems with each other or with the vehicle.

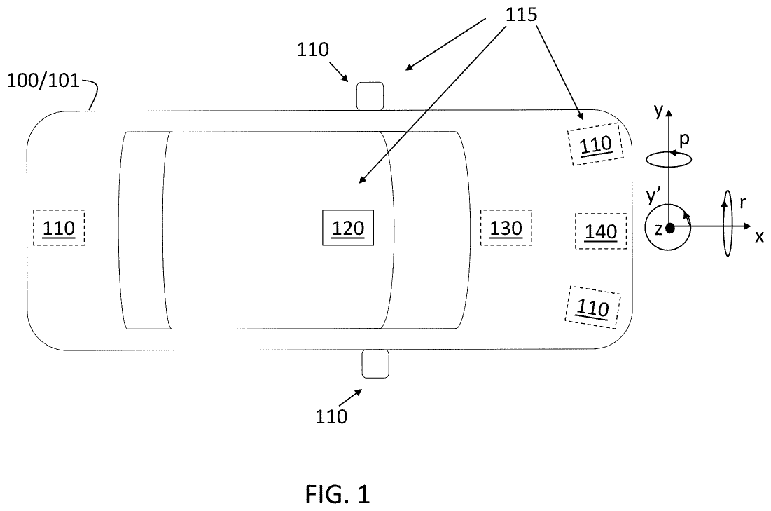

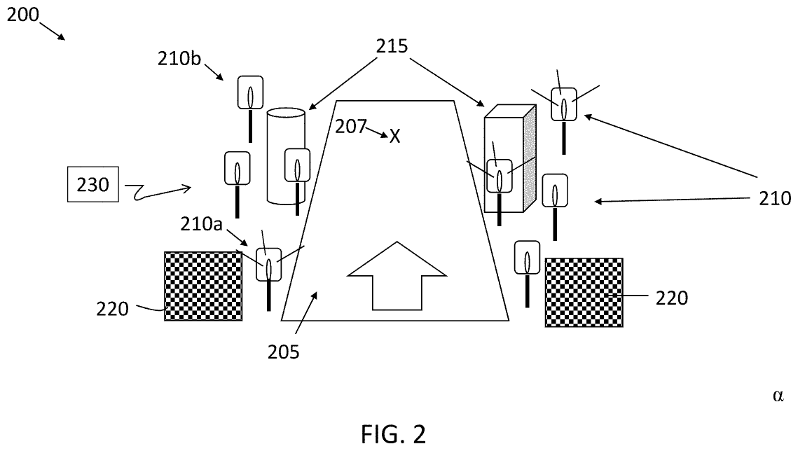

In accordance with an exemplary embodiment, FIG. 1 is a block diagram of a vehicle 100 that undergoes automatic optical sensor alignment using active targets 210 (FIG. 2). The exemplary vehicle 100 shown in FIG. 1 is an automobile 101. The vehicle 100 includes an exemplary five cameras 110 and a lidar system 120 shown in FIG. 1. The cameras 110 and lidar system 120 are generally referred to as optical sensors 115. The vehicle also includes other sensors 140 (e.g., radar system). The location and numbers of sensors are not limited by the exemplary illustration in FIG. 1.

A controller 130 may use information from one or more of the sensors 110, 120, 140 to control aspects of the operation of the vehicle 100. The controller 130 may perform aspects of the alignment process discussed herein alone or in conjunction with controllers within the sensors 110, 120, 140. The controller 130 and any controllers within the sensors 110, 120, 140 include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The coordinate system of the vehicle 100 is shown in FIG. 1. The direction of travel is along the x axis and the z axis is through the vehicle 100 according to the top-down view shown in FIG. 1. Alignment may involve determining the position (x, y, z) and orientation (pitch p, roll r, yaw y′) of a camera 110 or lidar system 120 relative to the vehicle 100 (e.g., to the front center of the vehicle 100). Alternately, alignment may involve determining the transformation (i.e., the rotation and translation) from the camera 110 or lidar system 120 coordinate system to the coordinate system of the vehicle 100. In further alternate embodiments pertaining to sensor fusion, for example, a camera 110 may be aligned with a lidar system 120 or another camera 110.

Known alignment techniques rely on features identified in images obtained by the optical sensors 115. In a simple case, for example, if the location of a feature in an image is known relative to the coordinate system of the vehicle 100, then alignment using the position and orientation of the feature in the image to the known location of the feature in the coordinate system of the vehicle 100 is a straight-forward process. More advanced alignment techniques are also known for scenarios in which the position of the vehicle 100 is not known (e.g., the vehicle 100 is moving), for example. The identification and location of features in the images is necessary to the known alignment techniques. As further discussed with reference to FIG. 2, active targets 210 are used in addition to passive targets 220 to more accurately identify the targets 210, 220 (i.e., features) for use in alignment of the optical sensors 115 according to one or more embodiments.

FIG. 2 depicts an exemplary station 200 with active targets 210 for automatic alignment of optical sensors 115 according to one or more embodiments. The station 200 may be part of a facility in which the vehicle 100 is manufactured, for example. The station 200 includes active targets 210 and passive targets 220. Active targets 210 refer to objects whose visible behavior can be altered while passive targets 220 are unchanging. That is, the active targets 210 have at least two visibly different states (e.g., illuminated and unilluminated) while the passive targets 220 have a single visible state. The exemplary active targets 210 shown in FIG. 2 are light emitting diodes (LEDs) and may be turned on or off, as shown. That is, active target 210a is on while active target 210b is off, for example. The LEDs may be different colors, and other exemplary active targets 210 include lasers.

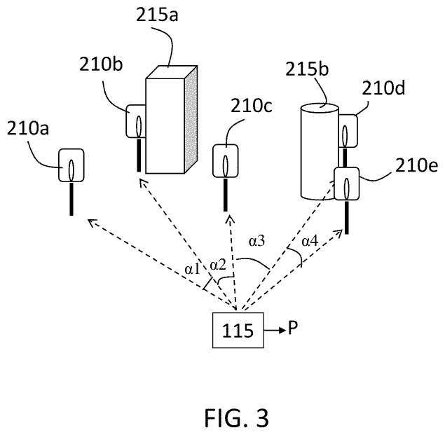

The active targets 210 may be coded according to their location (i.e., spatial coding) or their visible states in a number of ways to enhance the feature detection that is used for alignment. Spatial coding of the active targets 210 may be used alone or in conjunction with other coding. Particular active targets 210 are positioned in an identifiable way as further discussed with reference to FIG. 3. As previously noted, active targets 210 may also be coded according to their visible states (e.g., frequency coding, temporal coding). For example, the pattern of illumination among a number of active targets 210, a duty cycle of each active target 210, which effects brightness of illumination, and a frequency of illumination of each active target 210 may be controlled to improve feature detection. The frequency of illumination may be controlled to provide communication in exemplary embodiments. For example, a frequency-based code may be used to communicate the location of a given active target 210 or to communicate the identity of a given active target 210 whose location is known. The coding may be controlled by a controller 230 that includes processing circuitry similar to that discussed for the controller 130 in the vehicle 100 in FIG. 1.

The controller 230 may communicate with each active target 210 over wires (not shown) or wirelessly, as indicated in the exemplary case. The controller 230 may also communicate with the vehicle 100 (e.g., the controller 130) to convey the locations and codes of the active targets 210 and the locations of the passive targets 220. The active targets 210 and passive targets 220 are selected and positioned based on the particular vehicle 100 configuration (i.e., the location and numbers of the optical sensors) and occlusions 215 in the station 200. Once positioned, the location of each active target 210 and passive target 220 within the station 200 is known.

After the active targets 210 and passive targets 220 are positioned and the illumination of the active targets 210 is initiated according to a controlled code, images are obtained with the optical sensors 115 as the vehicle 100 moves along the path 205 through the station 200. According to an exemplary embodiment, the vehicle 100 may instead be stationary at a known position 207 (indicated by the “X” that would align with the front of the vehicle 100) along a path 205 through the station 200. The images obtained by the optical sensors 115 are processed to identify features (e.g., the active targets 210 and passive targets 220). The feature identification facilitates automatic alignment according to known techniques. The processes are further discussed with reference to FIG. 3.

FIG. 3 illustrates spatial coding of active targets 210 used for automatic optical sensor alignment according to one or more embodiments. For explanatory purposes, an exemplary set of active targets 210a through 210e (generally referred to as 210) and two exemplary occlusions 215a, 215b (generally referred to as 215) are shown to be in a field of view of an exemplary optical sensor 115 at one position of the optical sensor 115. The angular distance (i.e., apparent separation from the perspective of the optical sensor 115) is indicated between adjacent ones of the active targets 210 as α1, α2, α3, and α4. For example, α1=10 degrees, α2=20 degrees, α3=60 degrees, and α4=5 degrees. If the vehicle 100 (FIG. 1) on which the optical sensor 115 is disposed is moving, the active targets 210 may be identified from a series of images obtained by the optical sensor 115 based on the spatial coding, which is implemented through the known angular distances α1, α2, α3, and α4 between the active targets 210.

For example, if the active target 210b is occluded by the occlusion 215a, the active targets 210a and 210c will be captured in images obtained by the optical sensor 115, along with active targets 210d and 210e. The occlusion of active target 210b may occur because the optical sensor 115 (on the moving vehicle 100 (FIG. 1)) is at position P, for example. In this case, the angular distance between two of the active targets 210 detected in the image will be α1+α2 because active targets 210a and 210c will be detected. In addition, angular distances α3 and α4 will be detected. Active targets 210c, 210d, and 210e will be identified based on the known angular distances α3 and α4. Based on the remaining angular distance (α1+α2) and the knowledge of angular distances α1 and α2, respectively, between active targets 210a and 210b and 210b and 210c, the occlusion of active target 210b may be determined. Thus, spatial coding may facilitate identification of active targets 210, even without any other coding, and determination of occluded active targets 210.

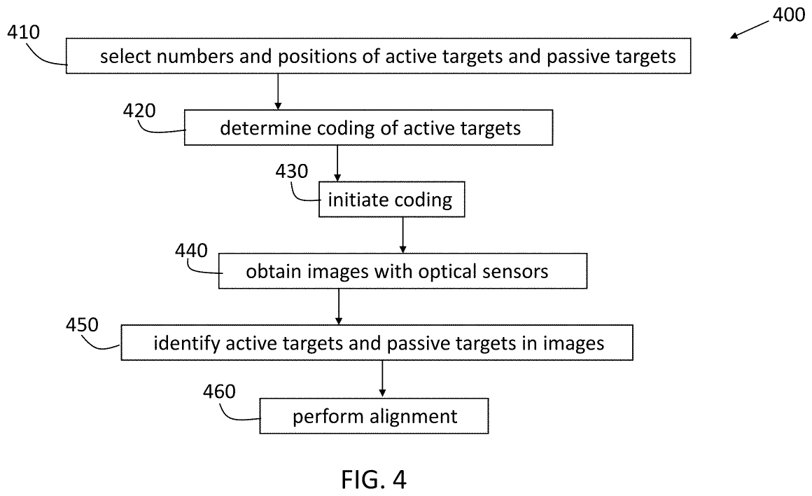

FIG. 4 is a process flow of a method 400 of using active targets 210 for automatic optical sensor alignment according to one or more embodiments. At block 410, selecting the numbers and positions of active targets 210 and passive targets 220 may be based on several factors. The position of the optical sensors 115 on or within the vehicle 100 is one of the factors that may be considered to ensure that at least one and, preferably, more than one target 210, 220 is within a field of view of each optical sensor 115. The alignment of interest is another factor that may be considered. For example, at least one active target 210 may be positioned closer and lower within a field of view of a camera 110 in order to accurately identify pitch. Occlusions 215 are another factor that may be considered in the placement of targets 210, 220. For example, a set of active targets 210 may be placed in the field of view of a camera 110 such that only one of the active targets 210 is blocked by an occlusion 215 when the vehicle 100 moves along the path 205 through the known position 207. The spatial coding discussed with reference to FIG. 3 influences the placement of the active targets 210 in consideration of occlusions 215 and to facilitate identification of the active targets 210. The exemplary factors are not intended to limit the considerations that may ultimately determine the positions of the targets 210, 220 in the station 200.

At block 420, determining coding of the active targets 210 may refer to controlling a pattern, duty cycle, or frequency (i.e., coding relating to the visible states of the active targets 210). Control of the active targets 210 may be performed by the controller 230, as noted with reference to FIG. 2. The coding relates to changing among the visible states of each active targets 210 (e.g., illuminated state, unilluminated state). The change in visible state according to the coding may be timed according to a frame rate of the optical sensors 115 such that a set of images obtained by the optical sensors 115 will capture the coding.

For example, a pattern of illumination for a set or subset of the active targets 210 in the field of view of an optical sensor 115 may be coordinated. The known pattern may then be used to identify the active targets 210 of the set or subset in images obtained by the optical sensor 115. Identifying the set or subset of active targets 210 may coarsely indicate a location within the station 200 of the active targets 210. The duty cycle of one or more active targets 210 may also be controlled. For example, the duty cycle may be reduced over time. In this case, images obtained during high duty cycles may include an area that is saturated due to the high intensity of the illumination of the active target 210. This area of saturation acts as a rough estimate of the location of the active target 210. As the duty cycle is reduced, a passive target 220 within the same field of view may become visible and may be used for more precise locating.

The frequency of one or more active targets 210 may be controlled, as well. The frequency may refer to how often a given active target 210 is illuminated. For example, a first active target 210 may switch between being illuminated and unilluminated every two frame durations of the optical sensors 115 while a second active target 210 may switch between being illuminated and unilluminated every one frame duration. This frequency can be determined by examining the active target 210 over a number of images and may facilitate identification of the first active target 210 versus the second active target 220, for example. The frequency may be mapped to a particular location or an identify, which in turn is associated with a particular location for the active target 210. Alternately, frequency may refer to a frequency-coded pattern of illumination (e.g., on-off-on-on over a number of image frames). This frequency code may also be mapped to a particular location or identify, which in turn is associated with a particular location for the active target 210. The frequency coding can convey any information as long as the code is known (i.e., a particular frequency-coded pattern of illumination is mapped to particular information).

At block 430, initiating coding refers to starting the operation of the active targets 210 according to the controlled pattern, duty cycle, and/or frequency established at block 420. At block 440, obtaining images with the optical sensors 115 refers to obtaining the images while the vehicle 100 is moving along the path 205 (e.g., along an assembly line in the station 200) or while the vehicle 100 is stationary at a known location 207 along the path 205 where the targets 210, 220 are positioned (at block 410). At block 450, identifying active targets 210 and passive targets 220 using the images obtained at block 440 may involve a set of processes. These processes involve image processing, which may be performed by the controller within each optical sensor 115, by the controller 130, or by a combination of the two. Generally, as previously noted, the active targets 210 may provide a coarse identification of the area of images that include the active targets 210 while the passive targets 220 facilitate more refined identification.

The feature detection required by the known alignment techniques refers to identifying a location, within the images (obtained at block 440), of the active targets 210 and passive targets 220. Tracking of a feature over a set of images and associating features among images is also part of known alignment techniques. Because the active targets 210, according to one or more embodiments, facilitate not only identification of a given active target 210 but also determination of its location within the station 200, as previously noted, the feature detection, tracking and association is enhanced through the use of the active targets. For example, if the vehicle 100 is at the known location 207 and an active target 210 is identified in an image and its location in the station 200 and its location in the coordinate system of the vehicle 100 is known, then aligning the optical sensor 115 that obtained the image is fairly straight-forward according to known techniques. The processes involved in the identification (i.e., feature detection) at block 450 are further discussed.

As part of the processing at block 450, the active targets 210 may be identified in the images first. The identification of the active targets 210 is enhanced by the pattern, duty cycle, and/or frequency coding described with reference to block 420. As previously noted, if the duty cycle of a given active target 210 is high, image saturation may occur such that only a rough estimate of the location of the given active target 210 may be obtained in an image. Once an active target 210 is identified based on the coding, its location within the station 200 is known. Thus, as another process at block 450, the location of passive targets 220 may be inferred based on the location of nearby active targets 210. An iterative process of obtaining images and performing image processing may be performed to refine the location estimation of active targets 210 and passive targets 220.

At block 460, performing alignment may refer to different types of alignment. For example, alignment at block 460 may refer to converting the coordinate system of one optical sensor 115 to that of another. This alignment may be needed to perform sensor fusion, for example. The alignment at block 460 may, instead, convert the coordinate system of an optical sensor 115 to the coordinate system of the vehicle 100. Regardless of what an optical sensor 115 is being aligned with, identification of active targets 210 and passive targets 220 at block 450 (i.e., the feature detection) and the knowledge of their location within the station 200 may be used with known techniques.

For example, if the vehicle is moving along an assembly line on the path 205 rather than at a known location 207, structure-from-motion (SfM) or motion stereo techniques may be employed. Both SfM and motion stereo facilitate extraction of three-dimensional information from a series of images obtained by a moving optical sensor 115. The three-dimensional information facilitates feature identification through the determination of common points (e.g., active target 210) among the images. The known alignment techniques that are facilitated by the feature identification are not detailed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of performing automatic alignment of an optical sensor of a vehicle, the method comprising:
disposing two or more active targets at known locations in an alignment station, each of the two or more active targets having at least two visibly different states at a given view; and
controlling, using a controller, a change among the at least two visibly different states for the two or more active targets, wherein images obtained by the optical sensor of the two or more active targets are processed to identify one or more of the two or more active targets and perform the alignment of the optical sensor with another sensor of the vehicle or with the vehicle.

2. The method according to claim 1, wherein the disposing the two or more active targets in the alignment station is based on a position of the optical sensor of the vehicle along a path past the two or more active targets in the alignment station.

3. The method according to claim 1, wherein the disposing the two or more active targets in the alignment station is based on a location of one or more occlusions blocking a view of the two or more active targets from the optical sensor.

4. The method according to claim 1, wherein the controlling includes implementing spatial coding of the two or more active targets based on relative position of the active targets.

5. The method according to claim 1, wherein the controlling includes defining a pattern of the change among the at least two visibly different states among the two or more active targets such that the pattern facilitates identification of the two or more active targets.

6. The method according to claim 1, wherein the controlling includes defining a duty cycle of each of the two or more active targets over a number of frame durations of the optical sensor, wherein the defining the duty cycle includes decreasing the duty cycle over the number of frame durations.

7. The method according to claim 1, wherein the controlling includes defining a different frequency for the change among the at least two visibly different states for different ones of the two or more active targets.

8. The method according to claim 1, wherein the controlling includes defining a different pattern of the change among the at least two visibly different states for different ones of the two or more active targets and the defining the different pattern of the change among the at least two visibly different states includes conveying an identify of the different ones of the two or more active targets based on the pattern of the change among the at least two visibly different states or conveying a location of the different ones of the two or more active targets based on the pattern of the change among the at least two visibly different states.

9. (canceled)

10. The method according to claim 1, further comprising disposing one or more passive targets at known locations in the alignment station, each of the one or more passive targets having a single visible state.

11. A system to perform automatic alignment of an optical sensor of a vehicle, the system comprising:
two or more active targets positioned at known locations in an alignment station, each of the two or more active targets having at least two visibly different states at a given view; and
a controller configured to control a change among the at least two visibly different states for the two or more active targets, wherein images obtained by the optical sensor of the two or more active targets are processed to identify one or more of the two or more active targets and perform the alignment of the optical sensor with another sensor of the vehicle or with the vehicle.

12. The system according to claim 11, wherein a position of the two or more active targets in the alignment station is based on a position of the optical sensor of the vehicle along a path past the two or more active targets in the alignment station.

13. The system according to claim 11, wherein a position of the two or more active targets in the alignment station is based on a location of one or more occlusions blocking a view of the two or more active targets from the optical sensor.

14. The system according to claim 11, wherein the two or more active targets are positioned by spatial coding based on relative position of the active targets.

15. The system according to claim 11, wherein the controller is configured to define a pattern of the change among the at least two visibly different states among the two or more active targets such that the pattern facilitates identification of the two or more active targets.

16. The system according to claim 11, wherein the controller is configured to define a duty cycle of each of the two or more active targets over a number of frame durations of the optical sensor, wherein the defining the duty cycle includes decreasing the duty cycle over the number of frame durations.

17. The system according to claim 11, wherein the controller is configured to define a different frequency for the change among the at least two visibly different states for different ones of the two or more active targets.

18. The system according to claim 11, wherein the controller is configured to define a different pattern of the change among the at least two visibly different states for different ones of the two or more active targets and the controller defines the different pattern of the change among the at least two visibly different states to convey an identify of the different ones of the two or more active targets based on the pattern of the change among the at least two visibly different states or to convey a location of the different ones of the two or more active targets based on the pattern of the change among the at least two visibly different states.

19. (canceled)

20. The system according to claim 11, further comprising one or more passive targets disposed at known locations in the alignment station, each of the one or more passive targets having a single visible state.

21. The method according to claim 1, wherein the another sensor of the vehicle is a different type of sensor than the optical sensor.

22. The method according to claim 11, wherein the another sensor of the vehicle is a different type of sensor than the optical sensor.
